(19) United States
(12) Patent Application Publication
(10) Pub. No.: US 2016/0209556 A1
(43) Pub. Date: Jul. 21, 2016

(54) LOW F/# LENS

(71) Applicant: Valve Corporation, Bellevue, WA (US)

(72) Inventor: Christian Dean DeJong, Sammamish, WA (US)

(21) Appl. No.: 14/599,242

(22) Filed: Jan. 16, 2015

(51) Int. Cl. G02B 3/08; G02B 27/00; G02B 27/30

(52) U.S. Cl. CPC G02B 3/08; G02B 27/30; G02B 27/0025

(57) ABSTRACT

Methods and systems are disclosed relating to low f/# lens with desirable imaging characteristics. In certain embodiments, the lens may include an aspheric surface and a Fresnel surface to produce one or more of the following characteristics: a large aperture; a wide field of view; a low spherical aberration and coma; a low field curvature; a monotonic field curvature for both tangential and sagittal planes; and significant but monotonic distortion. A variety of design forms may be used to accomplish the foregoing results including without limitation: an aspheric surface with a Fresnel asphere; a Forbes aspheric surface with a Fresnel asphere; an aspheric surface with a curved, 2-figure Fresnel lens; a Forbes aspheric surface with a curved, 2-figure Fresnel lens; and wide Fresnel zones. The lens may be a single element lens or a multi-element system including a thin field flattener or a negative lens for lateral color collection.

### FIELD OF THE DISCLOSURE

The disclosure relates generally to methods and systems for a low F/# lens for virtual reality displays and, more specifically according to aspects of certain embodiments, to a lens with an aspheric surface and a Fresnel lens.

### BRIEF DESCRIPTION OF THE DRAWINGS

By way of example, reference will now be made to the accompanying drawings, which are not to scale.

FIG. 1 depicts a layout of a conventional single-element lens.

FIG. 2 illustrates the field curvature and distortion of the single-element lens of FIG. 1.

FIG. 3 illustrates a conventional refractive lens and field flattener.

FIG. 4 illustrates the field curvature and distortion of the refractive lens and field flattener of FIG. 3.

FIG. 5 depicts a Fresnel lens and a refracting lens according to certain embodiments of the present invention.

FIG. 6 depicts a Fresnel lens according to certain embodiments of the present invention.

FIG. 7 illustrates the field curvature and distortion of the Fresnel lens of FIG. 6 according to certain embodiments of the present invention.

FIG. 8 depicts a curved Fresnel lens according to certain embodiments of the present invention.

FIG. 9 illustrates a single element lens with a Forbes aspheric front surface and a curved Fresnel rear surface according to certain embodiments of the present invention.

FIG. 10 illustrates the field curvature and distortion of the single element lens of FIG. 10 according to certain embodiments of the present invention.

### DETAILED DESCRIPTION

Those of ordinary skill in the art will realize that the following description of the present invention is illustrative only and not in any way limiting. Other embodiments of the invention will readily suggest themselves to such skilled persons, having the benefit of this disclosure. Reference will now be made in detail to specific implementations of the present invention as illustrated in the accompanying drawings. The same reference numbers will be used throughout the drawings and the following description to refer to the same or like parts.

In certain embodiments, virtual reality headsets use lenses to direct light associated with an image displayed on a panel to the eye. In certain embodiments, a lens with an aspheric front surface and a curved Fresnel lens rear surface may be thinner and lighter than a refracting lens. In addition, it may have a shorter focal length, and may have low spherical aberration, coma, astigmatism, and field curvature using a single element.

It is desirable to produce a lens with one or more of the following attributes: (a) a single-element lens; (b) an imaging lens; (c) a ratio of focal length to lens diameter (f/#) of about 1.0 to about 0.7; (d) a large aperture, which may fall between about 50 mm and about 70 mm; (e) a wide field of view; (f) low spherical aberration and coma; (g) low field curvature; (h) monotonic field curvature for both tangential and sagittal planes; (i) significant but monotonic distortion; (j) a pixel size between about 20 μm to about 100 μm; and (k) an image source with dimensions between about 30 mm×30 mm to about 80 mm×80 mm.

It is difficult to design a lens that has performance attributes (a) through (g) above using only spherical surfaces. Using only spherical surface, there are only two variables with which four aberrations (spherical, coma, field curvature, and astigmatism) need to be managed. The end result can be a spot size that grows rapidly off-axis. The addition of one or more aspheric surfaces according to aspects of the present invention may add flexibility and permit a useful lens to be designed. The aspheric terms may be able to control spherical aberration and coma quite well and have some control over field curvature and astigmatism. In certain embodiments, an imaging lens may be created that includes a monotonic field curvature for both tangential and sagittal planes. The aspheric surfaces may permit tangential field curvature to be non-monotonic.

A variety of design forms may be used to accomplish the foregoing results including without limitation: (1) an aspheric surface with a Fresnel asphere; (2) a Forbes aspheric surface with a Fresnel asphere; (3) an aspheric surface with a curved, 2-figure Fresnel lens; (4) a Forbes aspheric surface with a curved, 2-figure Fresnel lens; and (5) and wide Fresnel zones (e.g., greater than about 500 μm). The lens may be a single element lens or a multi-element system or assembly, which may include for example and without limitation a thin field flattener or a negative lens for lateral color collection.

According to aspects of the present invention, a front aspheric surface may be a Q-type or Forbes asphere. The rear Fresnel surface may have a base curve and an additive curve. The base curve may be fairly shallow and the curve may be preserved. The additional curve may be very strong and may, in certain embodiments be close to a parabola. The slope of the Fresnel surfaces is the sum of the slopes of the base curve and the additional curve.

In certain embodiments, an imaging lens for collimating light in a virtual reality headset is disclosed, including: a front aspheric refractive surface; and a rear Fresnel surface comprising a base curve and an additive curve. In certain embodiments, the imaging lens may collimate the light passing through it (i.e. make the output light more parallel than the input light) to improve the quality of an image viewed by a wearer of a virtual reality headset. The imaging lens may include a ratio of focal length to lens diameter between about 1.2 and about 0.5. The imaging lens may include a ratio of focal length to lens diameter between about 1.0 and about 0.7. The imaging lens may have a field of view with a radius of greater than about 40°. The imaging lens may include a lens diameter between about 40 mm and about 70 mm. The imaging lens may have a distortion greater than about 15% to create stereo overlap. The imaging lens may be configured to image a plurality of pixels between about 20 μm and about 100 μm. The imaging lens may have a maximum field curvature sag of less than 2.0 mm. The front aspheric refractive surface may include a conic. The front aspheric refractive surface may include a conic with aspheric coefficients. The front aspheric refractive surface may include an asphere without a conic. The front aspheric refractive surface may include a Forbes asphere without a conic. The front aspheric refractive surface may include a Forbes asphere and a conic. The rear Fresnel surface comprises a sphere. The rear Fresnel surface may include a conic. The rear Fresnel surface may include a conic with aspheric coefficients. The rear Fresnel surface may include an asphere without a conic. The rear Fresnel surface may include a Forbes asphere without a conic. The rear Fresnel surface may include a Forbes asphere and a conic. The imaging lens may be a single-element lens.

In certain embodiments, a lens assembly is disclosed including: a front aspheric surface; and a rear Fresnel surface comprising a base curve and an additive curve; wherein the lens assembly has a field curvature sag of less than about 1 mm in the field of view and less than about 1/10^{th} wave of spherical aberration. The lens assembly may be used for a virtual reality headset. The lens assembly may have a ratio of focal length to lens diameter between about 1.2 and about 0.5. The lens assembly may have a ratio of focal length to lens diameter between about 1.0 and about 0.7. The lens assembly may include a field of view with a radius greater than about 45° and a maximum field curvature sag of less than about 2.0 mm. The lens assembly may have an aperture between about 50 mm and about 70 mm. The lens assembly may have a monotonic field curvature for tangential and sagittal planes. The lens assembly may have a maximum field curvature sag of less than about 1 mm. The lens assembly may be configured to image a plurality of pixels between about 20 μm and about 100 μm. The lens assembly may include an image source between about 30 mm by 30 mm and about 80 mm by 80 mm. The lens assembly may include a Forbes aspheric surface. The rear Fresnel surface may include a Fresnel aspheric surface. The rear Fresnel surface may include a Fresnel aspheric surface. The rear Fresnel surface may include a two-figure Fresnel lens. The rear Fresnel surface may include a two-figure Fresnel lens. The rear Fresnel surface may include one or more Fresnel zones greater than about 500 μm. The rear Fresnel surface may include a curved Fresnel surface. The lens assembly may further comprise a thin field flattener. The lens assembly may further comprise a negative lens for lateral color correction.

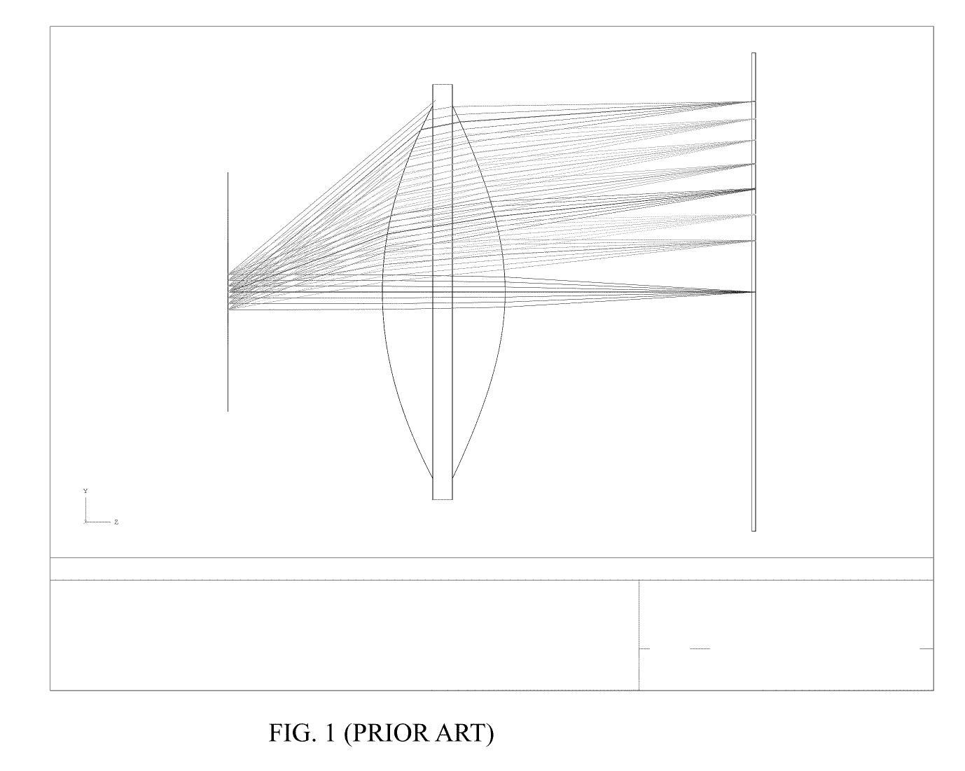

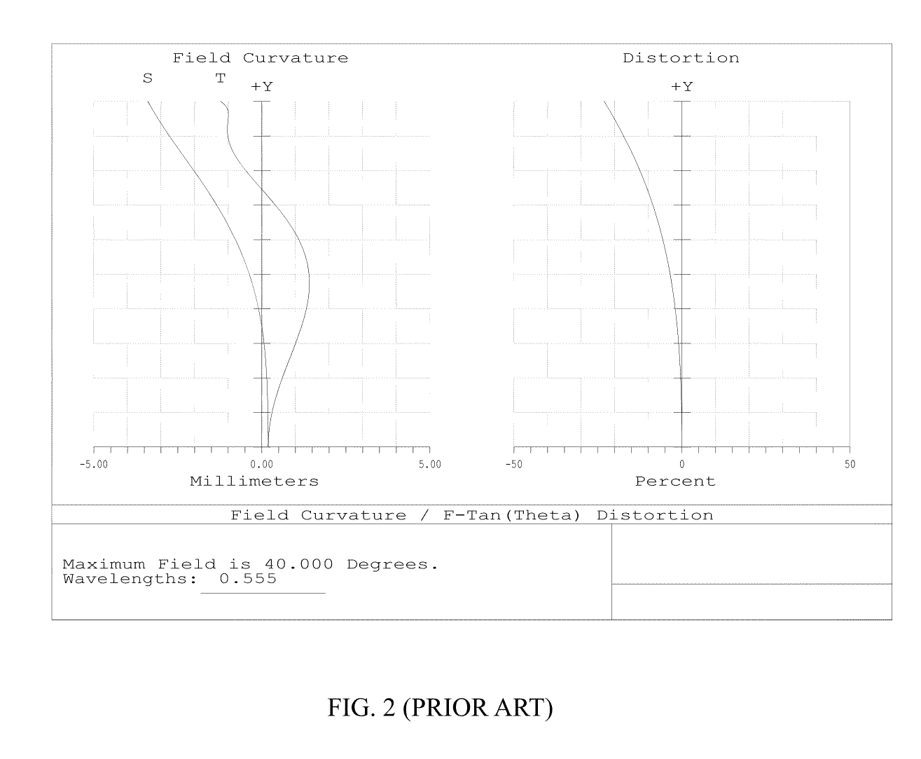

FIG. 2 depicts an example of the tangential and sagittal field curvature that may result from a conventional aspheric lens 110 as shown in FIG. 1. The magnitude of the field curvature may be fairly well controlled to about 1-3 mm for most of the field of view (FOV). At the edge of the FOV, the field curvature may grow significantly. This effect may be mitigated by reducing the FOV of the device slightly. The field curvature may change sign in the tangential direction, which may cause problems in virtual reality applications. The lens may produce substantial distortion. This distortion may be compensated for in the rendering. In certain embodiments, when the wearer of a Virtual Reality headset fixes his or her vision on an object in the Virtual world and turns his or her head, as the user's eye moves up the field curvature the object will shift slightly in one direction. As the slope of the field curvature reverses direction, the motion of the fixation object may also change direction. In the case of the above lens, the field curvature may peak at about +1.5 mm and then change direction and drop to about −1.0 mm, for a total shift of about 2.5 mm. The shift may be just a few pixels and still be perceptible. This behavior may be inconsistent with the user's real-life experience. The effect of this alternate stretching and contracting may erode the stability of the VR world and cause loss of immersion, eye strain and even nausea with prolonged use.

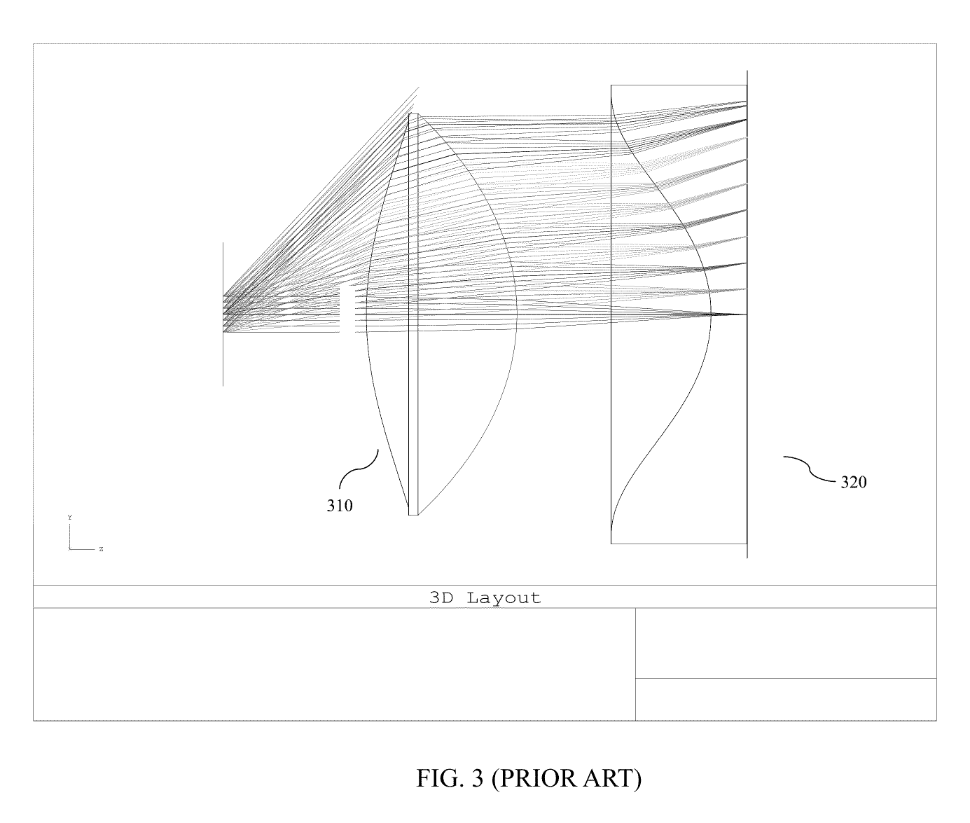

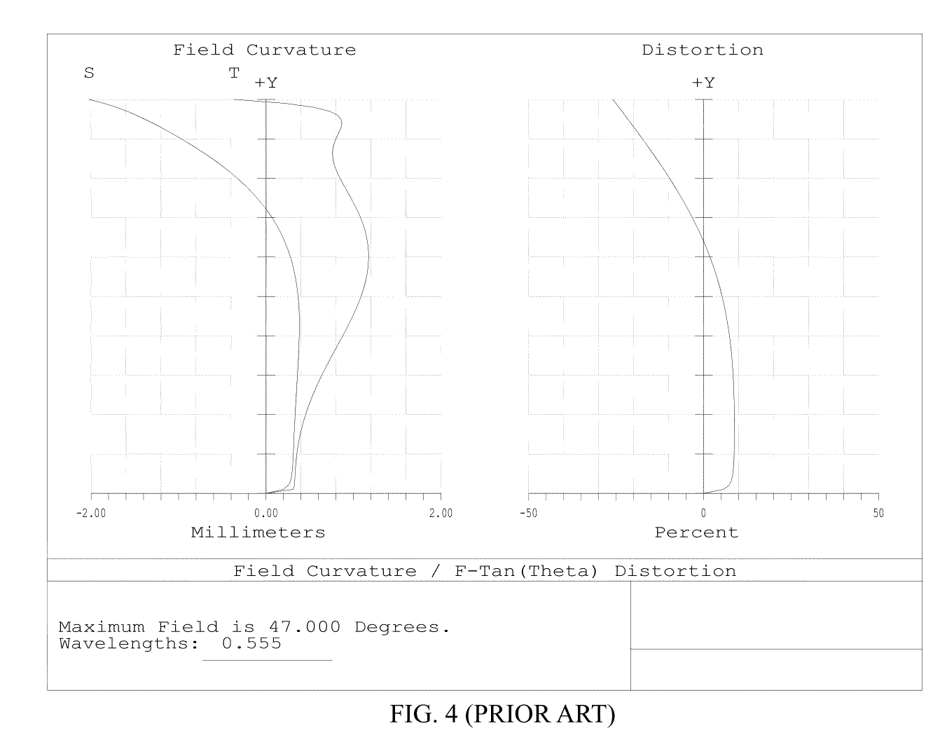

As shown in FIG. 3, one conventional solution is to add a second element 320 to refractive lens 310. This element is called a field flattener herein, and may be positioned close to the image source and if designed properly may correct much of the field curvature. For lenses in the f/# range for VR (roughly 0.7-1.2) the surfaces of the field flattener may be steeply sloped relative to the incident rays. This may result in significant reflection losses known as Fresnel reflection. Fresnel reflection may occur on all optical interfaces, windows, lenses, filters, water, or anytime light transitions from one media to another. The drawback to this approach is the addition of another element and two additional optical surfaces. This may increase the cost, complexity and total weight of the optics; the overall system length may be 10% larger in some cases. In addition, the weight of the additional lens is on a longer lever-arm as it is further from the face, making the headset less comfortable. There is also the loss of light and the increased difficulty of achieving a larger field of view, and the performance below that of the proposed solution. FIG. 4 shows the field curvature distortion in the exemplary configuration of FIG. 3 according to aspects of the present invention. Note the near axis change in the sign of the tangential field curvature.

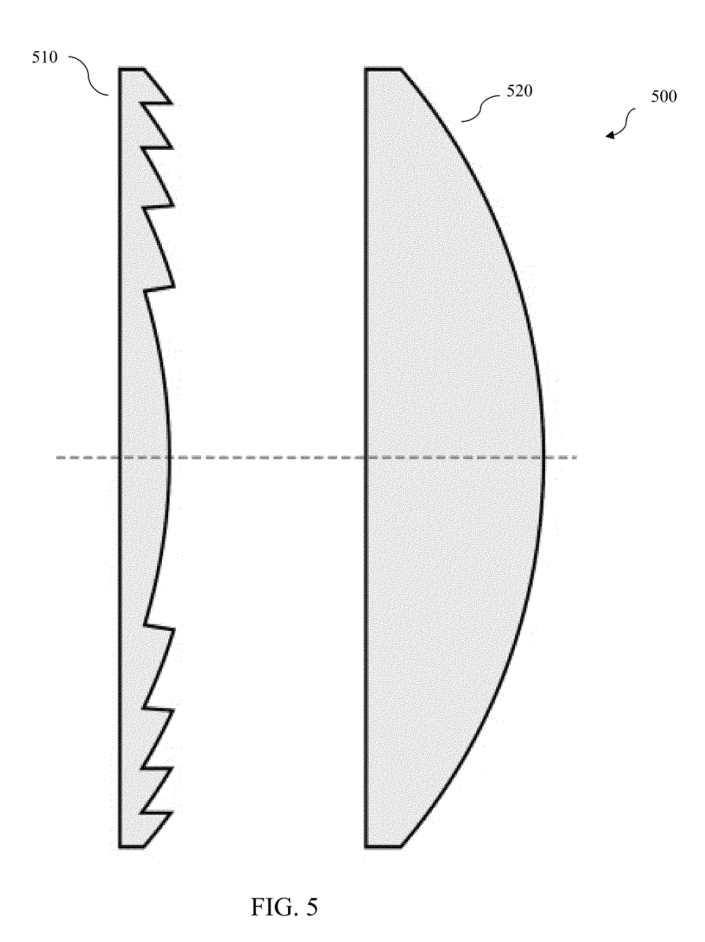

In certain embodiments, one of the surfaces may be replaced with a Fresnel lens surface. Generally Fresnel lenses have been regarded as not suitable for even modest field of view imaging applications with visible light. In certain embodiments, FIG. 5 displays a Fresnel lens 510 on the left, and a refractive lens 520 on the right.

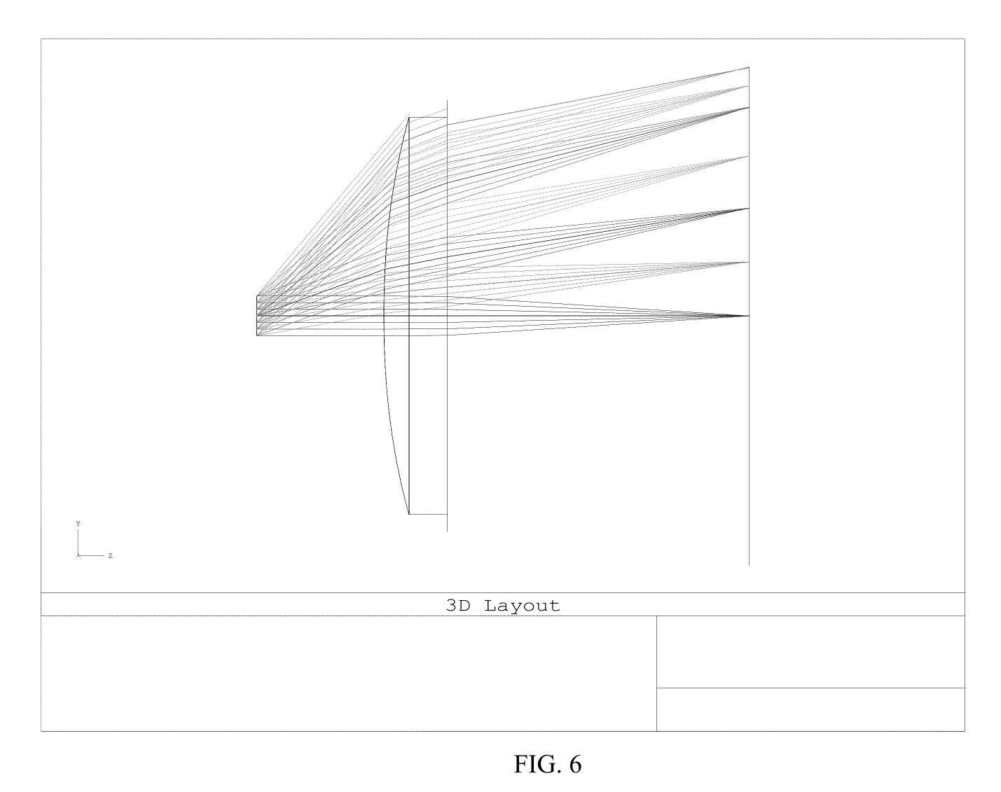

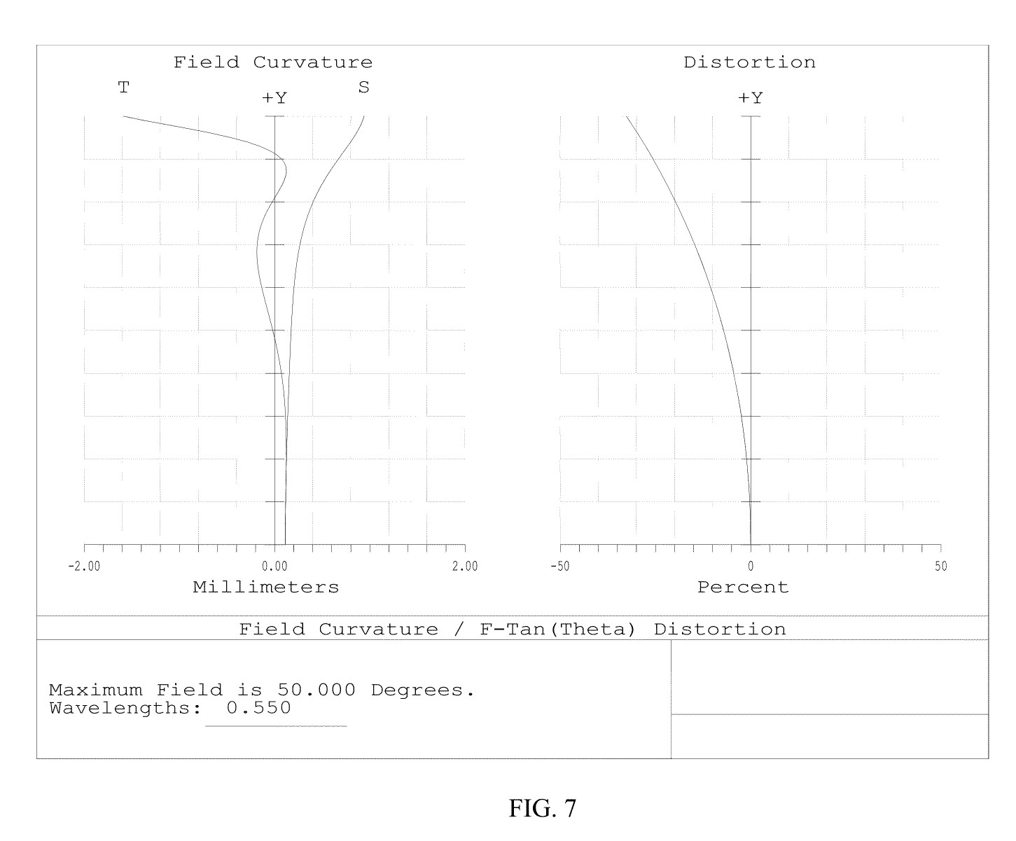

In certain embodiments, a Fresnel lens as shown in FIG. 6 may break the linkage between surface sag and optical power. As shown in FIG. 7, the addition of a Fresnel lens may allow the field curvature of the whole lens to be reduced. In certain embodiments, if a Forbes asphere is used on the refractive surface, then not only may aberration control be improved, but fabrication and testing may be easier. In the embodiment shown in FIGS. 6 and, the tangential field curvature has a high point just below +0.1 mm and then reverses to below around −0.05 mm. The result is a total change of field curvature of just 0.2 mm.

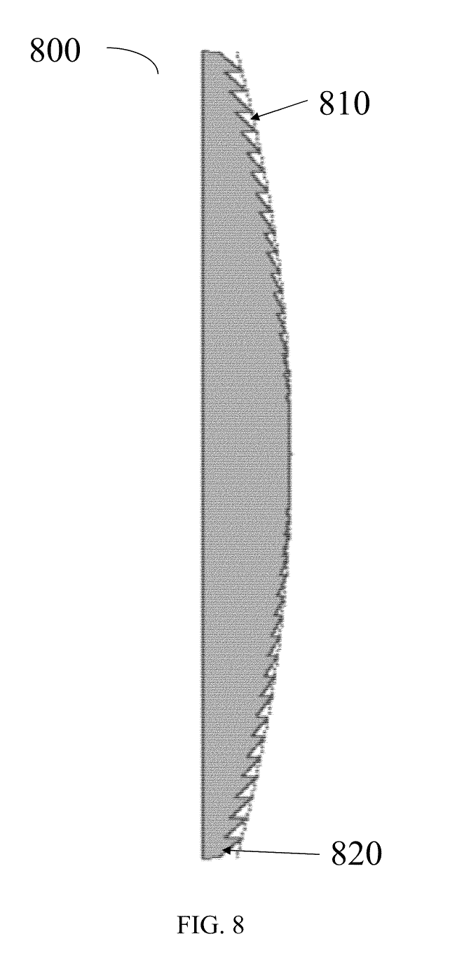

In certain embodiments as shown in FIG. 8, changing the flat Fresnel lens to a curved Fresnel lens 800 as shown in FIG. 8 may add additional flexibility to the design. In certain embodiments as shown in FIG. 8, a curved Fresnel surface may be described by two separate surface specifications. The first may be shown as dotted line 810 in FIG. 8. The second surface 820 is generally a more powerful surface. The local slope of the Fresnel surface 820 is the sum of the slope of the first surface 810 and a second surface more powerful surface.

The field curvature in certain embodiments as shown in FIG. 8 may not be monotonic but the variation may be small. The sign change of the tangential field curvature may be nearly monotonic with a deflection at the very edge of the FOV of about 0.2 mm. In this instance, the control of the sagittal field curvature may be much better than with the flat Fresnel surface. Fresnel lenses may also be effective in achieving the shorter focal length required for a panel as the smaller end of the scale (30 mm×30 mm).

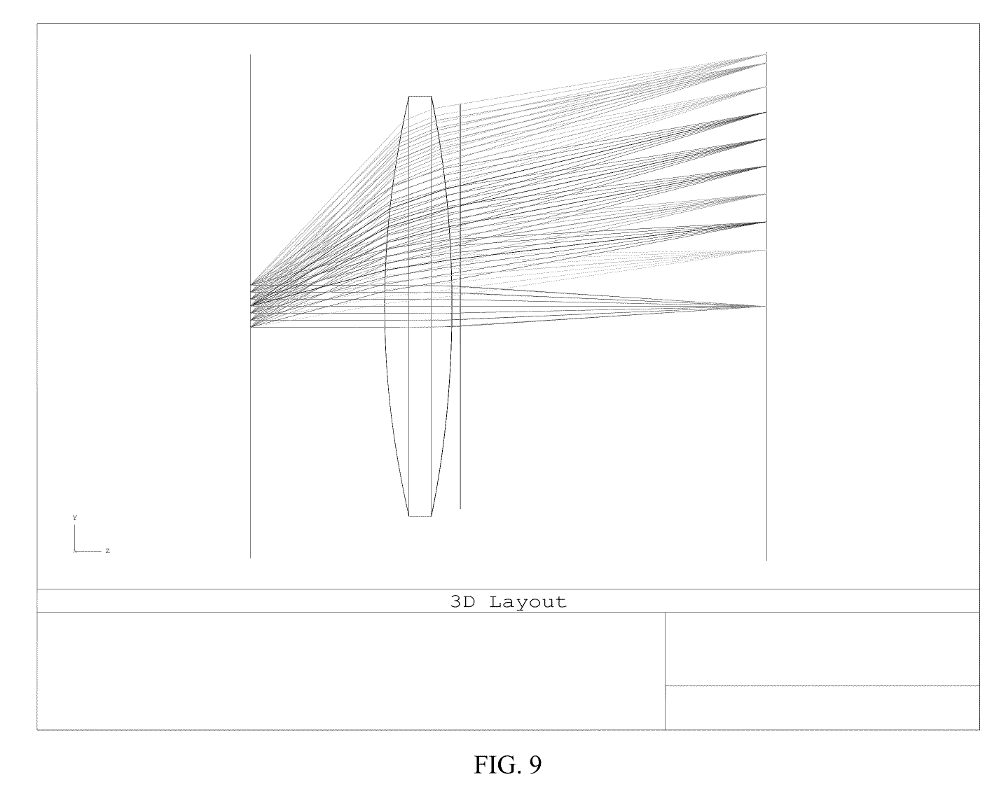

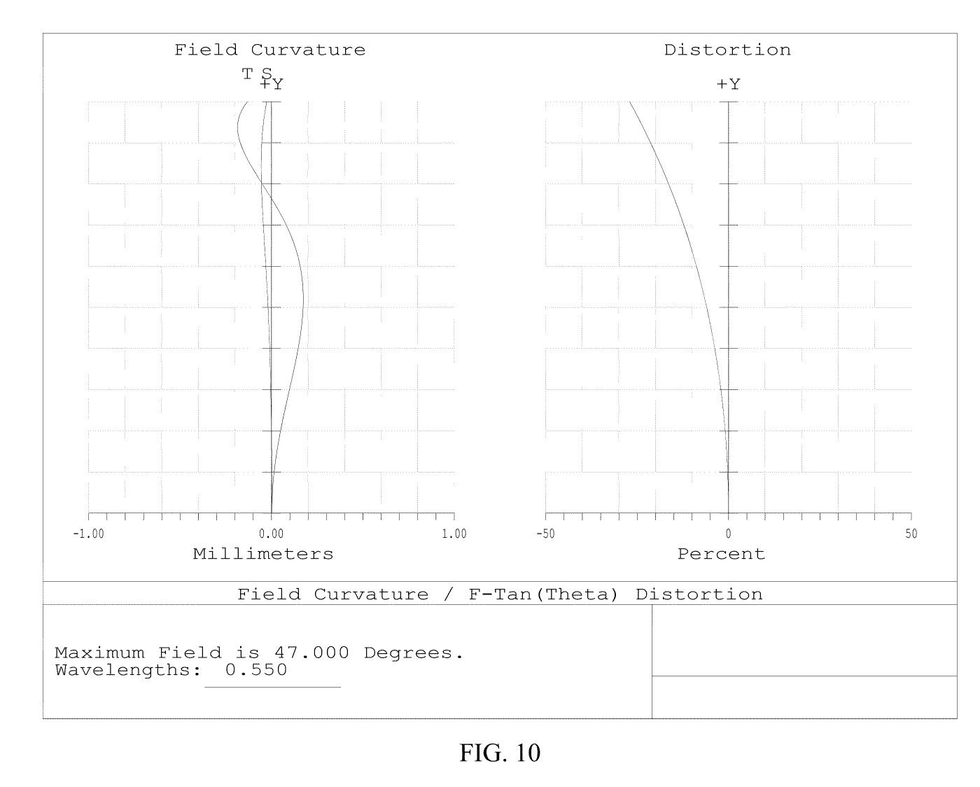

In certain embodiments as shown in FIG. 9, a single element lens may comprise a Forbes aspheric front surface and a curved Fresnel rear surface. As shown in FIG. 10, the single aspheric lens of FIG. 9 may exhibit reduced curvature with reduced size and weight compared to previous designs.

Many modifications and other embodiments of the invention will come to mind of one skilled in the art having the benefit of the teachings presented in the forgoing descriptions and the associated drawings. Therefore, it is understood that the invention is not to be limited to the specific embodiments disclosed, and that modifications and embodiments are intended to be included as readily appreciated by those skilled in the art.

While the above description contains many specifics and certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art, as mentioned above. The invention includes any combination or sub-combination of the elements from the different species and/or embodiments disclosed herein.

We claim:

1. An imaging lens for collimating light in a virtual reality headset, comprising:
a front aspheric refractive surface; and
a rear Fresnel surface comprising a base curve and an additive curve.

2. The imaging lens of claim 1, further comprising a ratio of focal length to lens diameter between about 1.2 and about 0.5.

3. The imaging lens of claim 2, further comprising a ratio of focal length to lens diameter between about 1.0 and about 0.7.

4. The imaging lens of claim 1, further comprising a field of view with a radius of greater than about 40°.

5. The imaging lens of claim 1, further comprising a lens diameter between about 40 mm and about 70 mm.

6. The imaging lens of claim 1, further comprising distortion greater than about 15% to create stereo overlap.

7. The imaging lens of claim 1, wherein the imaging lens is configured to image a plurality of pixels between about 20 μm and about 100 μm.

8. The imaging lens of claim 1, further comprising a maximum field curvature sag of less than 2.0 mm.

9. The imaging lens of claim 1, wherein the front aspheric refractive surface comprises a conic.

10. The imaging lens of claim 1, wherein the front aspheric refractive surface comprises a conic with aspheric coefficients.

11. The imaging lens of claim 1, wherein the front aspheric refractive surface comprises an asphere without a conic.

12. The imaging lens of claim 1, wherein the front aspheric refractive surface comprises a Forbes asphere without a conic.

13. The imaging lens of claim 1, wherein the front aspheric refractive surface comprises a Forbes asphere and a conic.

14. The imaging lens of claim 1, wherein the rear Fresnel surface comprises a sphere.

15. The imaging lens of claim 1, wherein the rear Fresnel surface comprises a conic.

16. The imaging lens of claim 1, wherein the rear Fresnel surface comprises a conic with aspheric coefficients.

17. The imaging lens of claim 1, wherein the rear Fresnel surface comprises an asphere without a conic.

18. The imaging lens of claim 1, wherein the rear Fresnel surface comprises a Forbes asphere without a conic.

19. The imaging lens of claim 1, wherein the rear Fresnel surface comprises a Forbes asphere and a conic.

20. The imaging lens of claim 1, wherein the image lens is a single-element lens.

21. A lens assembly for a virtual reality headset comprising:
a front aspheric surface; and
a rear Fresnel surface comprising a base curve and an additive curve;
wherein the lens assembly has a field curvature sag of less than about 1 mm in the field of view and less than about 1/10^{th} wave of spherical aberration.

22. The lens assembly of claim 21, further comprising a ratio of focal length to lens diameter between about 1.2 and about 0.5.

23. The lens assembly of claim 22, further comprising a ratio of focal length to lens diameter between about 1.0 and about 0.7.

24. The lens assembly of claim 22, further comprising a field of view with a radius greater than about 45° and a maximum field curvature sag of less than about 2.0 mm.

25. The lens assembly of claim 21, wherein the lens assembly comprises an aperture between about 50 mm and about 70 mm.

26. The lens assembly of claim 21, wherein the lens assembly comprises a monotonic field curvature for tangential and sagittal planes

27. The lens assembly of claim 26, further comprising a maximum field curvature sag of less than about 1 mm.

28. The lens assembly of claim 21, wherein the lens assembly is configured to image a plurality of pixels between about 20 μm and about 100 μm.

29. The lens assembly of claim 21, wherein the lens assembly further comprises an image source between about 30 mm by 30 mm and about 80 mm by 80 mm.

30. The lens assembly of claim 21, wherein the front aspheric surface comprises a Forbes aspheric surface.

31. The lens assembly of claim 21, wherein the rear Fresnel surface comprises a Fresnel aspheric surface.

32. The lens assembly of claim 30, wherein the rear Fresnel surface comprises a Fresnel aspheric surface.

33. The lens assembly of claim 21, wherein the rear Fresnel surface comprises a two-figure Fresnel lens.

34. The lens assembly of claim 30, wherein the rear Fresnel surface comprises a two-figure Fresnel lens.

35. The lens assembly of claim 21, wherein the rear Fresnel surface comprises one or more Fresnel zones greater than about 500 μm.

36. The lens assembly of claim 30, wherein the rear Fresnel surface comprises one or more Fresnel zones greater than about 500 μm.

37. The lens assembly of claim 21, wherein the rear Fresnel surface comprises a curved Fresnel surface.

38. The lens assembly of claim 30, wherein the rear Fresnel surface comprises a curved Fresnel surface.

39. The lens assembly of claim 21, further comprising a thin field flattener.

40. The lens assembly of claim 21, further comprising a negative lens for lateral color correction.
